(19) United States
(12) Patent Application Publication
(10) Pub. No.: US 2014/0051285 A1
(43) Pub. Date: Feb. 20, 2014

(54) ELECTRICAL CONNECTOR WITH INTEGRATED GROUNDING MEMBER AND GRIPPING SLEEVE

(71) Applicant: Amphenol Corporation, Wallingford, CT (US)

(72) Inventors: Zak W Raley, Killingworth, CT (US); Rakesh Thakare, Danville, VA (US); Richard Paglia, Springfield, MA (US); Bryan Blunt, Casa Grande, MA (US); Weixing Chen, Changzhou (CN); Minghua Gu, Changzhou (CN); Caichun Song, Changzhou (CN)

(73) Assignee: Amphenol Corporation, Wallingford, CT (US)

(21) Appl. No.: 14/028,355

(22) Filed: Sep. 16, 2013

Related U.S. Application Data
(63) Continuation-in-part of application No. 13/530,831, filed on Jun. 22, 2012.
Application No. 13/530,831 is a continuation of application No. 13/368,047, filed on Feb. 7, 2012, now Pat. No. 8,231,412.
Application No. 13/368,047 is a continuation of application No. 13/286,570, filed on Nov. 1, 2011, now abandoned.
(60) Provisional application No. 61/408,927, filed on Nov. 1, 2010.

(51) Int. Cl. H01R 9/05

(52) U.S. Cl. CPC H01R 9/0524
USPC 439/583

(57) ABSTRACT

An electrical connector that includes a connector body that has opposite first and second ends where the first end is configured to be coupled with a prepared end of a cable. A coupling member has an interface end configured to interface with a mating connector and a free end that is rotatable with respect to the connector body at the second end of the body. A gripping sleeve is configured to receive at least a portion of the coupling member and the connector body. The gripping sleeve includes a main body that has an internal bore with an inner surface. At least one electrically conductive grounding member disposed on the inner surface of the gripping sleeve. The grounding member has a coupling member contact surface and a connector body contact surface that provide a grounding path between the connector body and the coupling member.

### RELATED APPLICATION

This application is a continuation-in-part of copending commonly owned application Ser. No. 13/530,831, filed on Jun. 22, 2012, which is a continuation of application Ser. No. 13/368,047, filed on Feb. 7, 2012, which is a continuation of application Ser. No. 13/286,570, filed on Nov. 1, 2011, now abandoned, which claims priority to Provisional Application Ser. No. 61/408,927, filed Nov. 1, 2010.

### FIELD OF THE INVENTION

The present invention relates to an electrical connector, such as a coaxial cable connector, that has an integrated grounding member and gripping sleeve.

### BACKGROUND OF THE INVENTION

Coaxial cable connectors are typically used to connect a coaxial cable with a mating port or terminal of another device, such as equipment, appliances, and the like. For various reasons, such as movement of the equipment, vibrations, or improper installation of the connector, the connection between the coaxial connector and the mating port often becomes loose. That may result in a poor signal quality and RFI leakage due to the weak connection between the conductors of the mating port and coaxial cable. Therefore, a need exists for an alternative grounding path between those conductors that can compensate for a loose connection between the coaxial connector and its mating port.

Examples of prior art coaxial connectors with a grounding mechanism include U.S. Pat. Nos. 7,753,705 to Montena and 7,114,990 to Bence et al., the subject matter of each of which is hereby incorporated by reference.

### SUMMARY OF THE INVENTION

Accordingly, the present invention provides an electrical connector that includes a connector body that has opposite first and second ends where the first end is configured to be coupled with a prepared end of a cable. A coupling member has an interface end configured to interface with a mating connector and a free end opposite the interface end that is rotatable with respect to the connector body at the second end thereof. A gripping sleeve is configured to receive at least a portion of the coupling member and the connector body. The gripping sleeve includes a main body that has an internal bore configured to accommodate the at least a portion of the coupling member and the connector body, an outer surface that provides a gripping area portion, and an inner surface opposite the outer surface that has at least one grounding area portion where the grounding area portion is made of an electrically conductive material. The grounding area portion of the gripping sleeve contacts the coupling member and the connector body, thereby creating a grounding path between the connector body and the coupling member.

The present invention also provides an electrical connector that includes a connector body that has opposite first and second ends where the first end is configured to be coupled with a prepared end of a cable. A coupling member has an interface end configured to interface with a mating connector and a free end that is rotatable with respect to the connector body at the second end of the body. A gripping sleeve is configured to receive at least a portion of the coupling member and the connector body. The gripping sleeve includes a main body that has an internal bore with an inner surface. At least one electrically conductive grounding member is disposed on the inner surface of the gripping sleeve. The grounding member has a coupling member contact surface and a connector body contact surface that provide a grounding path between the connector body and the coupling member.

The present invention may further provide an electrical connector that includes a connector body having opposite first and second ends where the first end is configured to be coupled with a prepared end of a cable. A coupling member has an interface end that is configured to interface with a mating connector and a free end opposite the interface end that is rotatable with respect to the connector body at the second end of the connector body. A gripping sleeve is disposed on the coupling member such that the coupling member and the gripping sleeve are rotatable together with respect to the connector body. Means for grounding are located on the inner surface of the gripping sleeve. The means for grounding provides a grounding path between the connector body and the coupling member.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of an electrical connector in accordance with an exemplary embodiment of the present invention;

FIG. 2 is an exploded perspective view of the electrical connector illustrated in FIG. 1;

FIGS. 3A and 3B are cross-sectional and elevational views, respectively, of a grounding member of the electrical connector illustrated in FIG. 1;

FIG. 4. is a partial cross-sectional view of the electrical connector illustrated in FIG. 1;

FIG. 5 is an enlarged cross-sectional view similar to FIG. 4, showing the location of the grounding member;

FIG. 6 is a perspective view of an electrical connector with an integrated grounding member and gripping sleeve, according to an exemplary embodiment of the present invention;

FIG. 7A is a cross-sectional view of the electrical connector illustrated in FIG. 6, showing an integrated grounding member and gripping sleeve in accordance with a first embodiment of the present invention;

FIG. 7B is a partial enlarged view of the electrical connector illustrated in FIG. 7A;

FIG. 7C is a plan view of a grounding member of the electrical connector illustrated in FIG. 7A;

FIG. 8A is a cross-sectional view of the electrical connector illustrated in FIG. 6, showing an integrated grounding member and gripping sleeve in accordance with a second embodiment of the present invention;

FIG. 8B is a partial perspective view of a sleeve of the electrical connector illustrated in FIG. 8A;

FIG. 8C is a plan view of a grounding member of the electrical connector illustrated in FIG. 8B;

FIG. 8D is a cross-sectional view of the grounding member illustrated in FIG. 8C;

FIG. 9A is a cross-sectional view of the electrical connector illustrated in FIG. 6, showing an integrated grounding member and gripping sleeve in accordance with a third embodiment of the present invention;

FIG. 9B is a perspective view of a sleeve of the electrical connector illustrated in FIG. 9A, showing a grounding member disposed inside of the sleeve;

FIG. 9C is a perspective view of the grounding member illustrated in FIGS. 9A and 9B;

FIG. 10A is a cross-sectional view of the electrical connector illustrated in FIG. 6, showing an integrated grounding member and gripping sleeve in accordance with a fourth embodiment of the present invention;

FIG. 10B is an elevational view of the grounding member illustrated in FIGS. 10A;

FIG. 10C is an end view of the grounding member illustrated in FIG. 10B;

FIG. 11A is a cross-sectional view of an electrical connector in accordance with a fifth embodiment of the present invention, showing an integrated grounding member and gripping sleeve;

FIG. 11B is a perspective view of a gripping sleeve of the electrical connector illustrated in FIG. 11A;

FIG. 11C is a cross-sectional view the gripping sleeve and the grounding member of the electrical connector illustrated in FIG. 11A;

FIG. 11D is a perspective view of the grounding member illustrated in FIGS. 11A and 11C;

FIG. 12A is a perspective view of a gripping sleeve according to an exemplary embodiment of the present invention, showing the electrical connector received in the gripping sleeve;

FIG. 12B is an end view of the gripping sleeve illustrated in FIG. 12A;

FIG. 13A is an exploded perspective view of a gripping sleeve according to yet another exemplary embodiment of the present invention, showing the electrical connector being receivable in the gripping sleeve; and

FIG. 13B is an exploded end view of the gripping sleeve illustrated in FIG. 13A.

### DETAILED DESCRIPTION OF THE INVENTION

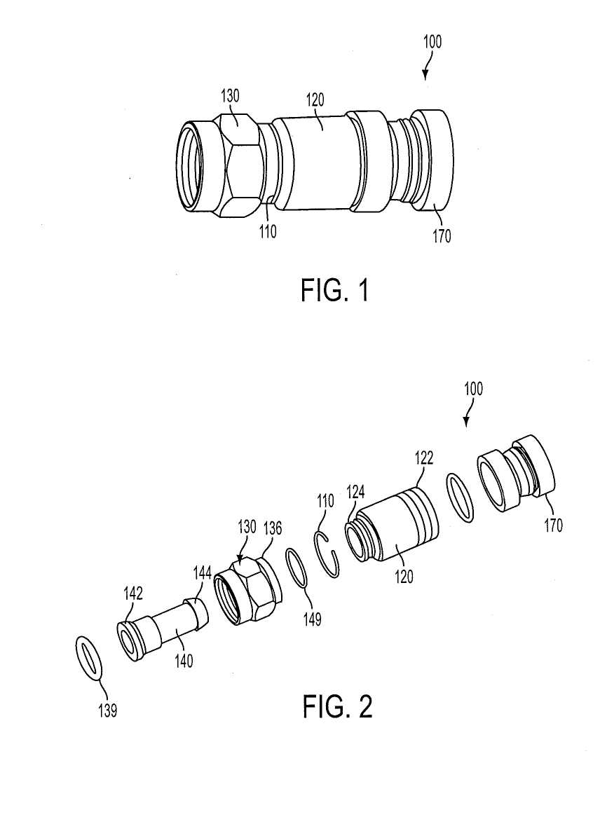

Referring to FIGS. 1, 2, 3A, 3B, 4, and 5, the present invention relates to an electrical connector 100, such as a coaxial connector, that includes a grounding member 110 which insures a continuous grounding path between a cable coupled to the connector 100 and a corresponding mating connector or port (not shown) of a device, such as a television, even if the connection therebetween becomes loose.

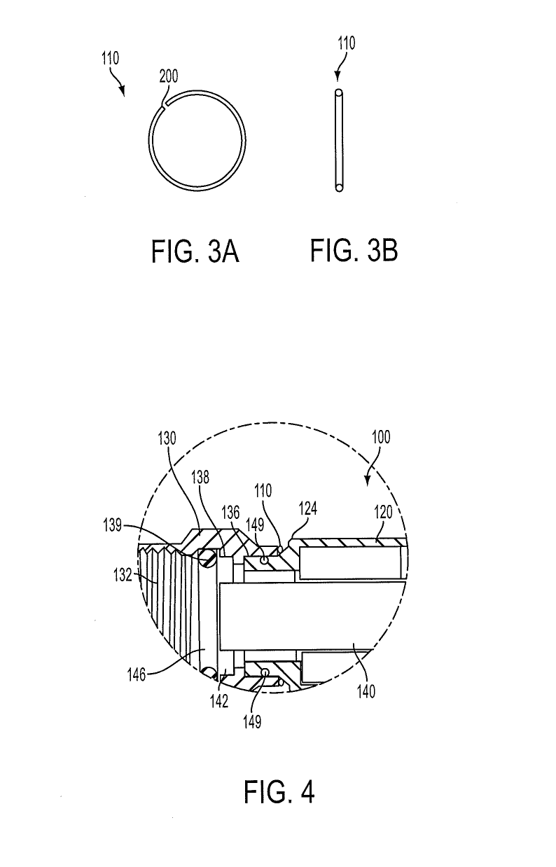

The connector 100 generally includes the grounding member 110, a connector body 120, a coupling member 130, and a post member 140. A compression ring 170 may be provided to facilitate termination of the cable with the connector. The grounding member 110, seen in FIGS. 3A and 3B, is disposed on the outside of the connector 100 to maintain electrical contact between the coupling member 130 and the connector body 120. Due to the grounding member 110, such electrical contact will be maintained even if the connection between the connector 100 and its mating connector or port becomes loose.

The post member 140 has a substantially tubular shape with an enlarged shoulder 142 at one end 146 adapted to couple with the coupling member 130, and an opposite end 144 designed to interface with a prepared end of a coaxial cable (not shown), as is well known in the art. The post member 140 is received in both the connector body 120 and the coupling member 130, as seen in FIG. 1, such that the coupling member 130 rotates with respect to the post member 140 at the end 146, and the connector body 120 engages the post member 140 in a tight or friction fit.

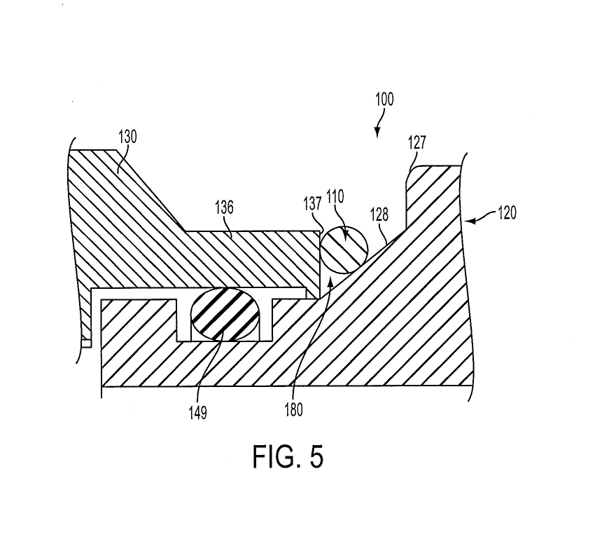

The coupling member 130 is preferably a nut with internal threads 132, as best seen in FIGS. 1 and 2, and is adapted to engage external threads of a mating connector or port. The coupling member 130 includes an interface end 134 which engages the mating connector and an opposite free end 136 with an end face surface 137 (FIG. 5). Near the free end 136 of the coupling member 130 is an internally extending shoulder 138 that catches the enlarged shoulder 142 of the post member 140, thereby rotatably coupling the coupling member 130 to the post member 140. An O-ring 139 is preferably provided inside of the coupling member 130 to prevent moisture migration.

As seen in FIGS. 1 and 2, the connector body 120 is generally tubular in shape with a first end 122 adapted to couple with the prepared end of the cable, as is well known in the art, and a opposite tapered second end 124 that engages the post member 140. At its second end 124, the connector body 120 may include a transition portion 126 that may have a transition shoulder 127 and a tapered surface 128. Alternatively, the transition portion 126 may just have a tapered surface or may be a series of tapered shoulders. The transition portion 126 meets the free end 136 of the coupling member 130, as seen in FIG. 1. A gap 180, as seen in FIG. 5, exists between the transition portion of the connector body 120 and the end face surface 137 of the coupling member 130. That gap 180 may vary due to tolerances in the connector. An O-ring 149 may be provides between the overlap of the free end 136 of the coupling member 130 and the second end 124 of the connector body 120 to prevent moisture migration.

As seen FIGS. 2, 3A and 3B, the grounding member 110 is preferably a ring that is resilient to form a tight fit over the connector body 120 and the coupling nut 130. For example, the grounding member 110 may be a spring coil, wave washer, star washer and the like. Alternatively, the grounding member 110 may be a conductive O-ring. The grounding member 110 may include a cutout portion 200 (FIG. 3A) to facilitate assembly of the grounding member 110 on the connector 100. As seen in FIGS. 4 and 5, the grounding member 110 preferably sits in the gap 180 between the free end 136 of the coupling member 130 and the second end 124 of the connector body 120. In particular, the grounding member 110 may be in contact with adjacent surfaces of the components, that is in contact with the transition portion 126 of the connector body's second end 124 and the end surface of the coupling member's free end 136. Because the grounding member 110 is resilient, it will remain in place and provide a consistent grounding path between the connector body 120 and the coupling member 130. Although, it is preferably that the grounding member 110 be located in the gap 180, the grounding member 110 may be located any outer or exposed surface of the connector body 120 and the coupling member 130 as long as the grounding member is in contact with adjacent surfaces of both components to maintain electrical continuity therebetween.

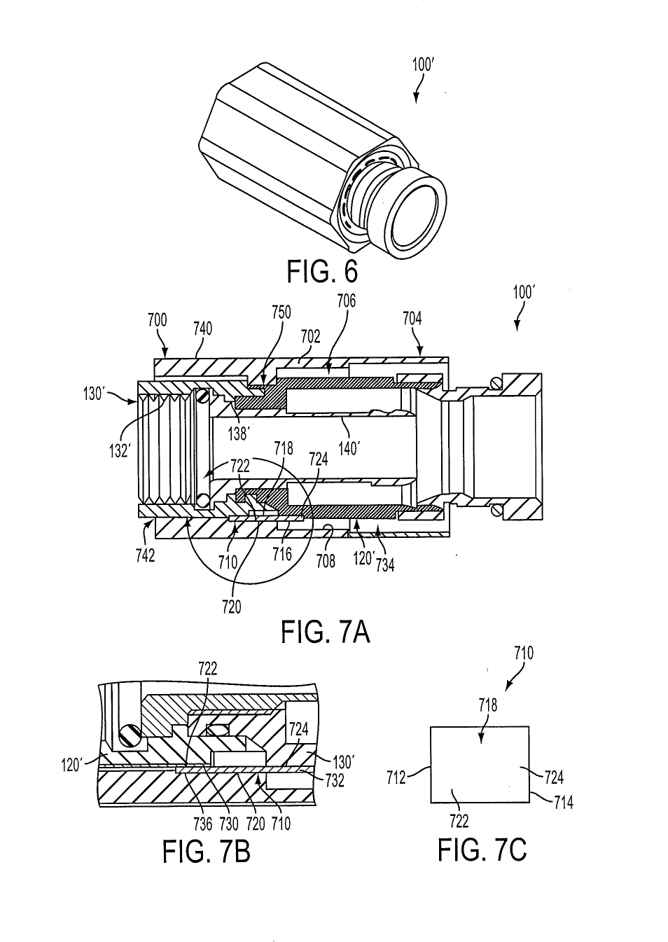

Referring to FIGS. 6 and 7A-7C, an electrical connector 100′ according to another exemplary embodiment of the present invention includes a gripping sleeve 700 that incorporates a grounding area portion, such as a grounding member 710, that functions similarly to grounding member 110 in that it creates a grounding path between the coupling member or nut 130′ and the connector body 120′.

As seen in FIGS. 7A-7C, the grounding member 710 may be integrated with a gripping sleeve 700. The gripping sleeve 700 generally includes a main body 702 that has an outer surface 704 that facilitates gripping of the connector 100′ and an internal bore 706 adapted to receive the connector 100′. The outer surface 704 preferably has a gripping area portion 740 that may be, for example, longitudinal ribs (FIG. 6), knurls, and the like. The internal bore 706 includes a first end 742 that engages the coupling member or nut 130′ of the connector 100′ such that the gripping sleeve 700 and the nut 130′ rotate together. The first end 742 of the bore 706 may be shaped to substantially match the shape of the nut 130′ such that an interference fit is formed therebetween, for example. The second end 734 of the internal bore 706 accommodates at least some or all of the connector body 120′ of the connector 100′.

The internal bore 706 of the gripping sleeve 700 includes an inner surface 708 that preferably has a grounding area portion that contacts both the nut 130′ and the connector body 120′ when the gripping sleeve 700 is installed on the electrical connector 100′ to provide the grounding path. The grounding area portion is preferably the grounding member 710 disposed on the inner surface 708. In a preferred embodiment, the grounding member 710 sits in a recessed area 736 of the inner surface 708. The grounding member 710 may be secured to the inner surface 708 by any known manner, such as molding the sleeve 700 with the grounding member 710, by interlocking, by press-fit, by adhesive or the like.

The grounding member 710 may be a conductive or metal segment (FIG. 7C) that generally includes first and second ends 712 and 714 and opposite first and second sides 716 and 718. The first side 716 of the metal segment 710 includes a sleeve engaging surface 720. The opposite second side 718 includes both a nut contact surface 722 near the first end 712 and a body contact surface 724 near the second end 714. The nut and body contact surfaces 722 and 724 are preferably substantially co-planar with respect to one another and engage outer surfaces of the nut 130′ and the connector body 120′. However, the surfaces 722 and 724 may also not be co-planar. An outer surface of the nut 130′ may be any surface of the nut 130′ that is not inside the nut 130′, such as at the internal threads 132′ and/or internally extending shoulder 138′. An outer surface of the body 120′ is any surface of the body 120′ that is not on the inside of the body 120′ where the post 140′ is received in the body 120′. The length of the grounding member 710 should be long enough to contact both the nut 130′ and the body 120′. In this embodiment, the nut contact surface 722 engages an outer surface 730 of the nut 130′ and the body contact surface 724 engages an outer surface 732 of the connector body 120′, as best seen in FIG. 7B. Although only one grounding member 710 is illustrated in FIGS. 7A-7C, more than one grounding member 710 may be provided on the inner surface 708 of the sleeve 700.

The gripping sleeve 700 may optionally include a retaining member 750 in the internal bore 706, as seen in FIG. 7A. The retaining member 750 may be an internally extending annular flange, for example, that preferably extends in the gap between the nut 130′ and the connector body 120′ when the sleeve 700 is installed on the connector. The retaining member 750 generally prevents axial movement of the sleeve with respect to the connector 100′, thereby generally preventing the sleeve from slipping off of the connector. The flange 750 may extend continuously around the internal bore 706 of the sleeve 700 or may be discontinuous to form a plurality of ledges extending into the bore 706.

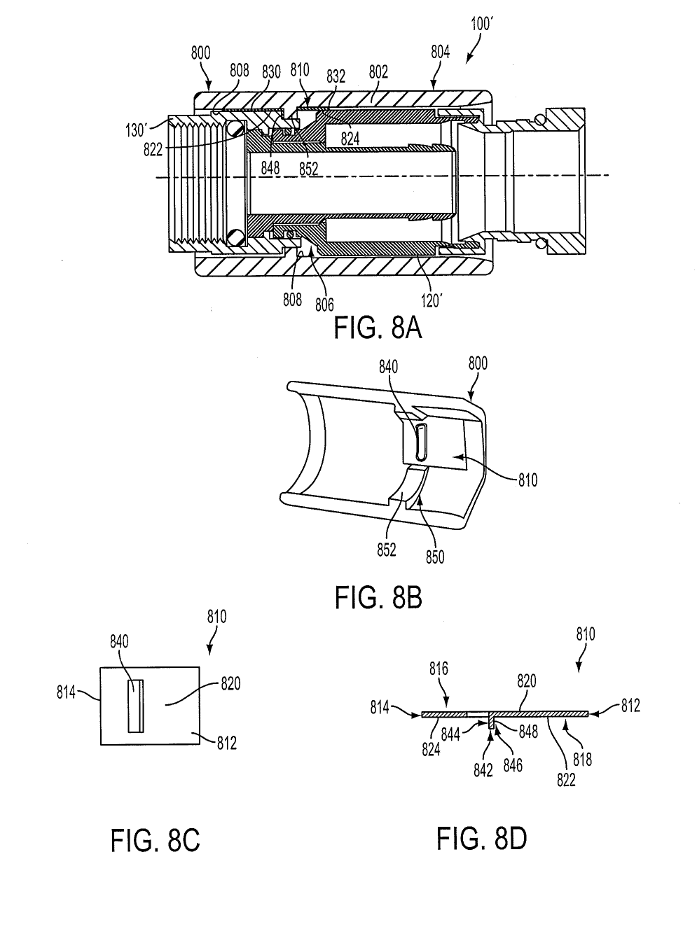

FIGS. 8A-8C illustrate a second embodiment of a gripping sleeve 800 and a grounding member 810 integrated therein. The sleeve 800 and the grounding member 810 are similar to sleeve 700 and grounding member 710 of the first embodiment in that the sleeve 800 facilitates gripping and torque of the connector 100′ and that the grounding member 810 provides a conductive path between the nut 130′ and the body 120′.

Like the gripping sleeve 700 of the first embodiment, the gripping sleeve 800 generally includes a main body 802, an outer surface 804 that facilitates gripping of the connector 100′ and an internal bore 806 adapted to receive the connector 100′. The internal bore 806 of the gripping sleeve 800 includes an inner surface 808 that has the grounding area portion or grounding member 810. The gripping sleeve 800 preferably includes a retaining member 850 that may be a flange around the inner surface 808 of the sleeve 800. The flange 850 is preferably discontinuous to form a plurality of ledges 852.

The grounding member 810 may be a conductive or metal segment (FIG. 8C) similar to the grounding member 710 of the first embodiment and generally includes first and second ends 812 and 814 and opposite first and second sides 816 and 818. The grounding member 810 may include a cut-out section 840 (FIG. 8C) with a leg section 842 (FIG. 8D) extending therefrom. The leg section 842 may be substantially perpendicular to the main portion of the grounding member 810. The first side 816 includes a sleeve engaging surface 820 and the cut-out section 840 is shaped to receive one of the ledges 852 (FIG. 8B) on the inner surface 808, thereby holding the grounding member 810 in the internal bore 806. The grounding member 810 may also be molded with the sleeve 800, press-fit or adhered to the sleeve 800.

The opposite second side 818 of the grounding member 810 includes both a primary nut contact surface 822 near the first end 812 and a body contact surface 824 near the second end 814. The nut and body contact surfaces 822 and 824 are preferably substantially co-planar with respect to one another and engage outer surfaces of the nut 130′ and the connector body 120′. However, the surfaces 822 and 824 may also not be co-planar. The length of the grounding member 810 should be long enough to contact both the nut 130′ and the body 120′. In this embodiment, the primary nut contact surface 822 engages an outer surface 830 of the nut 130′ and the body contact surface 824 engages an outer surface 832 of the connector body 120′, as best seen in FIG. 8A.

The leg section 842 of the grounding member 810 has opposite faces 844 and 846, as seen in FIG. 8D. One face 844 may be adjacent to or contact the ledge 852 of the sleeve 800 that is extending through the cut-out section 840 of the grounding member 810. The opposite face 846 may include a secondary nut contact surface 848 (FIG. 8A) that engages the outer surface 830 of the nut 130′ at a location spaced from where the primary nut contact surface 822 engages the nut 130′. For example, the primary nut contact surface 822 may engage the gripping area of the nut's outer surface 830 and the secondary nut contact surface 848 may engage the end face of the nut's outer surface 830.

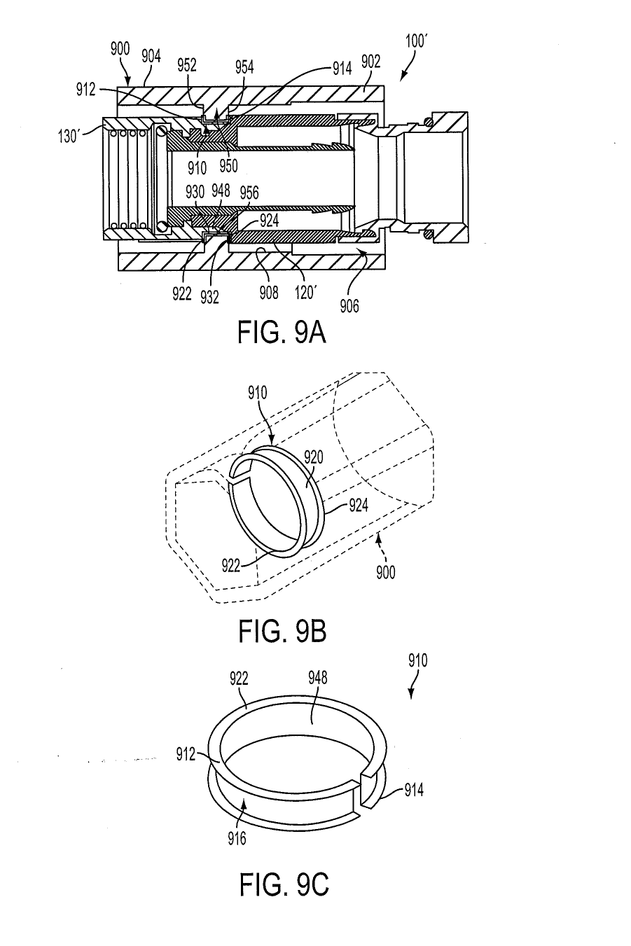

FIGS. 9A-9C illustrate a third embodiment of a gripping sleeve 900 and a grounding member 910 integrated therein similar in function to the first and second embodiments in providing a grounding path between the nut 130′ and the body 120′.

Gripping sleeve 900 generally includes a main body 902, an outer surface 904 that facilitates gripping of the connector 100′ and an internal bore 906 with an inner surface 908 adapted to receive the connector 100′. The gripping sleeve 900 may include a retaining member 950 that is preferably an annular flange extending around the inner surface 908 of the sleeve 900. Although it is preferable that the flange 950 extends continuously around the inner surface 908, the flange 950 may be discontinuous. The flange 950 may have opposite radially extending faces 952 and 954 and an annular inner surface 956 therebtween. The flange 950 preferably extends into the gap between the body ′120 and the nut ′130 when the sleeve 900 is installed on the connector. The flange 950 preferably has a grounding area portion that supports the grounding member 910, as seen in FIG. 9A.

The grounding member 910 is formed of a conductive material and may include a resilient ring body 916 (FIG. 9C) with first and second walls 912 and 914 extending therefrom, thereby forming a generally U-shaped cross-section. The ring body 916 includes a sleeve engaging surface 920 that rests on the annular inner surface 956 of the sleeve's flange 950. The first and second walls 912 and 914 extend along the opposite faces 952 and 954, respectively, such that the flange 950 is received in the U-shaped cross-section of the grounding member 910. The grounding member 910 is held on the flange 950 in any known manner, such as overmolding, interlocking, press-fit, adhesive, and the like.

The first wall 912 of the grounding member 910 includes a primary nut contact surface 922 near on the outside thereof such that when the sleeve 900 is installed on the connector, the first wall 912 is sandwiched between the free end of the nut 130′ and the sleeve's flange 950. The second wall 914 of the grounding member 910 includes a body contact surface 924 on the outside thereof such that the second wall 914 is sandwiched between the outer surface of the connector body 120′ and the flange 950. The width or length of the flange 950 and the grounding member 910 is sized so that the when fitted in the gap, positive contact is made between the primary nut contact surface 922 and the outer surface 930 of the nut ′130 and between the body contact surface 924 and the outer surface 932 of the body 120′, as best seen in FIG. 9A.

A secondary nut contact surface 948 may be provided on the outside of the ring body 916 that engages the outer surface of the nut ′130 at its free end. The second nut contact surface 948 is preferably spaced from and substantially perpendicular with respect to the primary nut contact surface 922.

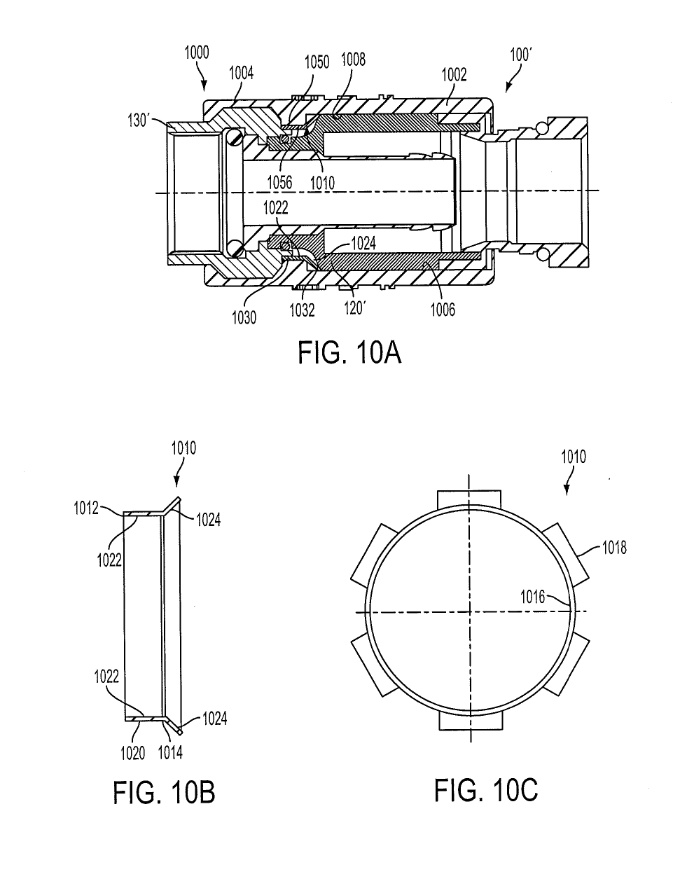

FIGS. 10A-10D illustrate a fourth embodiment of a gripping sleeve 1000 and integrated grounding member 1010. Like the gripping sleeves of the above embodiments, the gripping sleeve 1000 generally includes a main body 1002, an outer surface 1004, and an internal bore 1006 with an inner surface 1008 adapted to receive the connector 100′. The gripping sleeve 1000 may include a retaining member 1050 that is preferably an annular flange extending around the inner surface 1008 of the sleeve 1000. The flange 1050 may be continuous or discontinuous. The flange 1050 may have an annular inner surface 1056 that extends into the gap between the body ′120 and the nut ′130 when the sleeve 1000 is installed on the connector. The flange 1050 preferably has a grounding area portion that supports the grounding member 1010, as seen in FIG. 10A.

The grounding member 1010 is formed of a conductive material and generally includes a ring body 1016 (FIG. 10B) with opposite first and second ends 1012 and 1014 and a plurality of resilient fingers 1018 (FIG. 10C) extending from the second end 1014. The outside of the ring body 1016 includes a sleeve engaging surface 1020 that rests on the annular inner surface 1056 of the sleeve's flange 1050. The grounding member 1010 is held on the flange 1050 in any known manner, such as overmolding, interlocking, press-fit, adhesive, and the like.

The inside of the ring body 1016 of the grounding member 1010 includes a nut contact surface 1022 such that when the sleeve 1000 is installed on the connector, the ring body 1016 is sandwiched between the inner surface 1008 of the sleeve 1000 and the free end of the nut ′130. Each of the fingers 1018 of the grounding member 1010 includes a body contact surface 1024 on the ends. The length of the grounding member 1010 is sized so that the when fitted in the gap, positive contact is made between the nut contact surface 1022 and the outer surface 1030 of the nut ′130 and between the body contact surfaces 1024 of the fingers 1018 and the outer surface 1032 of the body 120′, as best seen in FIG. 10A.

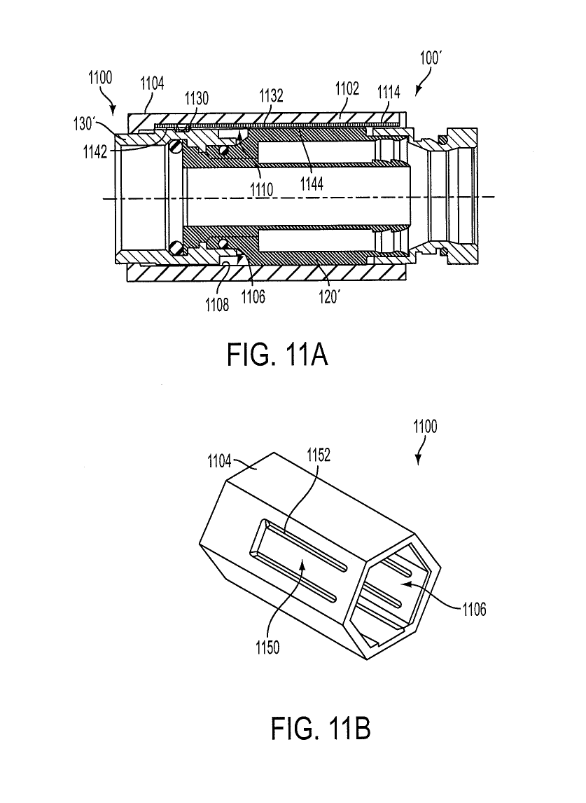

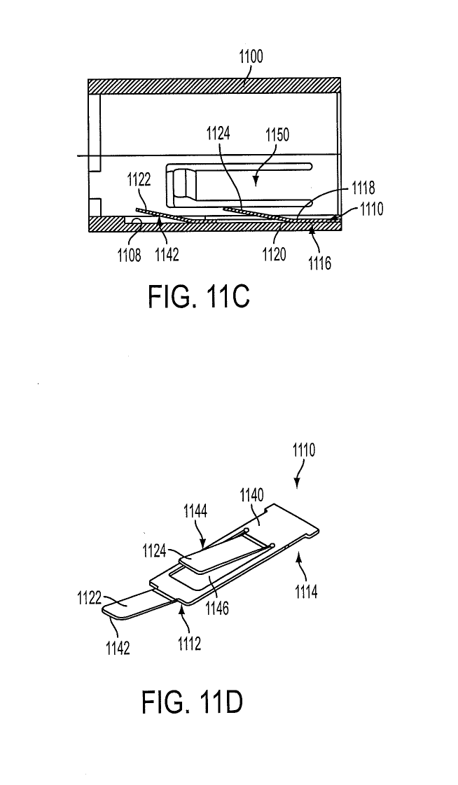

FIGS. 11A-11D illustrate a fifth embodiment of a sleeve 1100 and a grounding member 1110 integrated therein. The sleeve 1100 and the grounding member 1110 function similarly to the above embodiments in facilitating gripping and providing a conductive path between the nut 130′ and the body 120′.

As seen in FIG. 11B, the gripping sleeve 1100 generally includes a main body 1102, an outer surface 1104 that facilitates gripping of the connector and an internal bore 1106 adapted to receive the connector. The walls of the sleeve 1100 may include one or more resilient tabs 1150 (FIG. 11B) that each has a lip 1152 on the end thereof extending into the internal bore 1106. The inner surface 1108 of the internal bore 1106 includes a grounding area portion for supporting the grounding member 1110.

As seen in FIGS. 11A, 11C, and 11D, the grounding member 1110 may include a main body 1140 (FIG. 11D) that is a metal segment with first and second ends 1112 and 1114 and opposite first and second sides 1116 and 1118. The first side 1116 includes a sleeve engaging surface 1120 that engages the inner surface 1108. The grounding member 1110 may include a first resilient tab 1142 (FIG. 11D) extending from the first end 1112 and a second resilient tab 1144 (FIG. 11D) extending from a cutout section 1146 of the main body 1140. A cutout section 1146 is sized to receive one of the tabs 1150 of the sleeve 1100 to retain the grounding member 1110 on the inside of the sleeve 1100. When the sleeve 1100 is installed on the connector, the first end 1112 of the grounding member 1110 is sandwiched between the outer surface of the nut ′130 and the inner surface 1108 of the sleeve 1100 and the second end 1114 is sandwiched between the outer surface of the body ′120 and the inner surface 1108 of the sleeve 1100.

The first resilient tab 1142 may include a nut contact surface 1122 on the inside thereof and the second resilient tab 1144 may include a body contact surface 1124 on the inside thereof, as seen in FIGS. 11C and 11D. The length of the grounding member 1110 should be long enough so that the tabs 1142 and 1144 can contact the nut 130′ and the body 120′, respectively. In this embodiment, the nut contact surface 1122 engages an outer surface 1130 of the nut 130′ and the body contact surface 1124 engages an outer surface 1132 of the connector body 120′, as best seen in FIG. 11A.

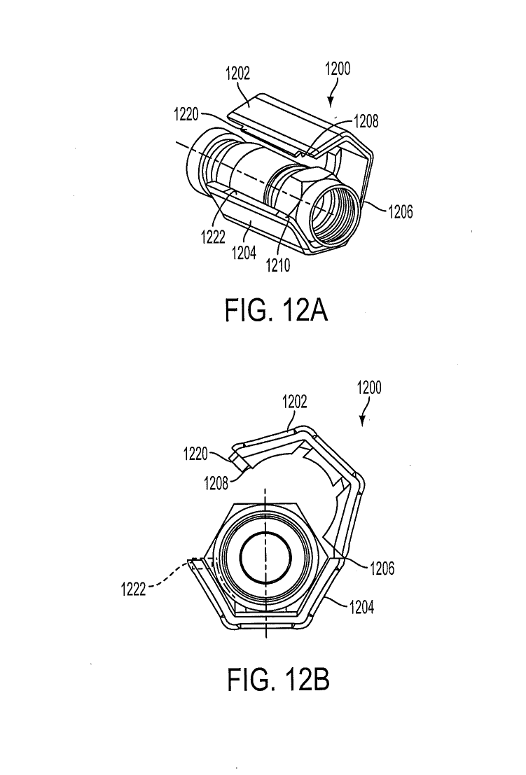

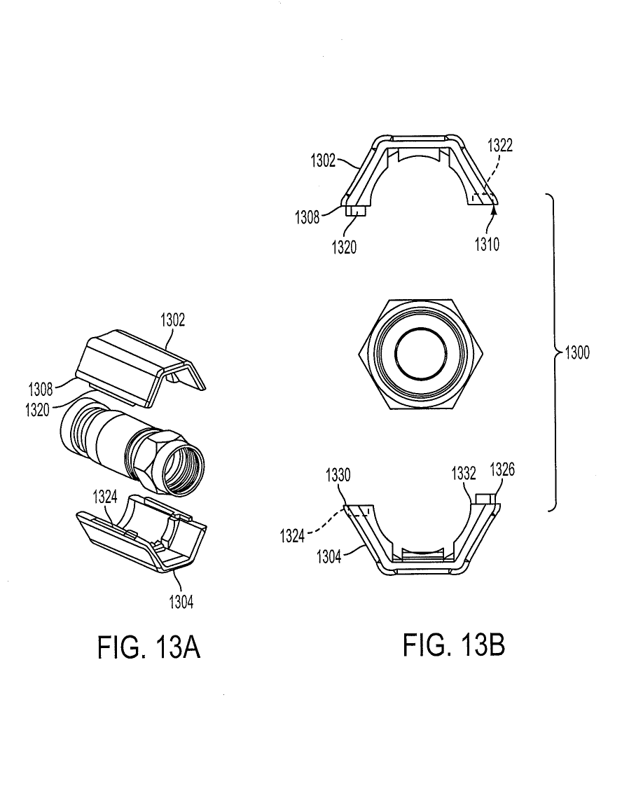

While the gripping sleeves of the above embodiments may be formed as one-piece, the gripping sleeves may alternatively be formed of two pieces to facilitate assembly with the electrical connector, as illustrated in the embodiments of FIGS. 12A-12B and 13A-13B. The gripping sleeves of all of the embodiments may be made of a plastic material. Alternatively, the gripping sleeves may formed of metal or metalized plastics, such that the inner surface of the sleeve contacts the nut and the body of the connector to form the grounding path. In such an embodiment, the need for a separate grounding member can be eliminated. In yet another embodiment, all or portions of the inner surface of the gripping sleeve may be plated or otherwise coated or covered in a conductive material or the gripping sleeve may be partially or completely comprised of a conductive material, to provide the grounding area portion and grounding path between the nut and the body.

FIGS. 12A and 12B illustrate a gripping sleeve 1200 according to an exemplary embodiment of the present invention that generally includes first and second pieces 1202 and 1204 hinged together at a hinge 1206. The first and second pieces 1202 and 1204 are adapted to mate via alignment member 1220 and 1222, respectively. For example, the alignment member 1220 on the first piece 1202 may be a key extending for at least part of the length of the piece 1202 at an edge 1208 thereof and the alignment member 1222 may be a corresponding slot formed in the edge 1210 of the second piece 1204. The electrical connector may be retained in the gripping sleeve 1200 when the key 1220 of the first piece 1202 is received in the slot 1222 of the second piece 1204. Alternatively, the key may be provided on the second piece 1204 and the slot in the first piece 1202. The key 1220 and the slot 1222 may have any shape as long as the shapes thereof correspond to each other for mating alignment. The alignment members may also be eliminated such that the edges of the first and second pieces 1202 and 1204 opposite the hinge 1206 are secured together in any known manner, such as adhesive.

FIGS. 13A and 13B illustrate yet another gripping sleeve 1300 according to an exemplary embodiment of the present invention. Similar to the gripping sleeve 1200, the gripping sleeve 1300 includes first and second pieces 1302 and 1304. Unlike the gripping sleeve 1200, the pieces 1302 and 1304 of the gripping sleeve 1300 are not hinged together and are separate. Instead of a hinge, corresponding alignment members are provided at both ends of the pieces 1302 and 1304. For example, the first piece 1302 may have a first alignment member 1320, such as a key, at a first end edge 1308 and a second alignment member 1322, such as a slot, at the opposing second end edge 1310. The second piece 1304 may likewise have a third alignment member 1324, such as a slot, at a first end edge 1330 and a fourth alignment member 1326, such as a key, at the opposing second end edge 1332. The electrical connector is retained in the gripping sleeve 1300 when the first and third alignment members 1320 and 1324, e.g. key and slot, are engaged, and the second and fourth alignment members 1322 and 1326 are likewise engaged. The alignment members may also be eliminated such that the first edges 1308 and 1330 of the two pieces 1302 and 1304 and their second edges 1310 and 1332 are secured together in any known manner, such as adhesive.

While particular embodiments have been chosen to illustrate the invention, it will be understood by those skilled in the art that various changes and modifications can be made therein without departing from the scope of the invention as defined in the appended claims. For example, one or more grounding members of the above embodiments may be provided inside the sleeve to provide a conductive grounding path between the nut and connector. Also, the length of the grounding members of the above embodiments may vary as long as the grounding member contacts the outer surface of both the nut and the body.

What is claimed is:

1. An electrical connector, comprising:
a connector body having opposite first and second ends, said first end being configured to be coupled with a prepared end of a cable;
a coupling member having an interface end configured to interface with a mating connector and a free end opposite said interface end that is rotatable with respect to said connector body at said second end of said connector body; and
a gripping sleeve configured to receive at least a portion of said coupling member and said connector body, said gripping sleeve including,
a main body having an internal bore configured to accommodate said at least a portion of said coupling member and said connector body, an outer surface providing a gripping area portion, and an inner surface opposite said outer surface having at least one grounding area portion, said grounding area portion being made of an electrically conductive material,
wherein said grounding area portion of said gripping sleeve contacts said coupling member and said connector body, thereby creating a grounding path between said connector body and said coupling member.

2. An electrical connector according to claim 1, wherein
said grounding area portion of said gripping sleeve has a coupling member contact surface and a connector body contact surface, said coupling member contact surface engaging an outer surface of said coupling member and said connector body contact surface engaging an outer surface of said connector body.

3. An electrical connector according to claim 1, wherein
said inner surface of said gripping sleeve includes a retaining member; and
said grounding area portion is located on or near said retaining member.

4. An electrical connector according to claim 3, wherein
said retaining member is a radially inwardly extending flange.

5. An electrical connector according to claim 4, wherein
said flange is discontinuous.

6. An electrical connector according to claim 1, wherein
said grounding area portion of said gripping sleeve is a metal segment.

7. An electrical connector according to claim 6, wherein
said metal segment has a coupling member contact surface and a connector body contact surface, said coupling member contact surface engaging an outer surface of said coupling member and said connector body contact surface engaging an outer surface of said connector body.

8. An electrical connector according to claim 7, wherein
said metal segment has a length sufficient to span a gap between said coupling member and said connector body.

9. An electrical connector according to claim 7, wherein
said coupling member contact surface and said connector body contact surface are co-planar.

10. An electrical connector according to claim 6, wherein
said metal segment has a cut-out section and an inwardly extending leg section; and
a second coupling member contact surface is disposed on said leg section for engaging said outer surface at the free end of said coupling member.

11. An electrical connector according to claim 1, further comprising
a post member that is insertable into said connector body for coupling to the prepared end of the cable; and
said coupling member being rotatably coupled to an end of said post member.

12. An electrical connector according to claim 1, wherein
said grounding area portion is a grounding member that includes a ring body.

13. An electrical connector according to claim 12, wherein
said ring body engages a retaining member of said internal bore of said gripping sleeve.

14. An electrical connector according to claim 12, wherein
said ring body includes a coupling member contact surface engaging an outer surface of said coupling member and a connector body contact surface engaging an outer surface of said connector body.

15. An electrical connector according to claim 14, wherein
said ring body is substantially U-shaped in cross-section.

16. An electrical connector according to claim 14, wherein
said ring body includes a plurality of resilient fingers; and
said connector body contact surface is on said fingers.

17. An electrical connector according to claim 1, wherein
said grounding area portion is a metal segment with first and second resilient tabs, said first tab having a coupling member contact surface for engaging an outer surface of said coupling member and said second tab having a connector body contact surface for engaging an outer surface of said connector body.

18. An electrical connector according to claim 17, wherein
said metal segment includes a cut-out section adapted to receive a tab of said gripping sleeve.

19. An electrical connector according to claim 1, wherein
said inner surface of said gripping sleeve is plated or coated with a conductive material at said grounding area portion.

20. An electrical connector according to claim 1, wherein
said gripping sleeve is partially or completely formed of a conductive material.

21. An electrical connector, comprising:
a connector body having opposite first and second ends, said first end being configured to be coupled with a prepared end of a cable;
a coupling member having an interface end configured to interface with a mating connector and a free end opposite said interface end that is rotatable with respect to said connector body at said second end of said connector body;
a gripping sleeve configured to receive at least a portion of said coupling member and said connector body, said gripping sleeve including a main body having an internal bore with an inner surface; and
at least one electrically conductive grounding member disposed on said inner surface of said gripping sleeve, said grounding member having a coupling member contact surface and a connector body contact surface that provide a grounding path between said connector body and said coupling member.

22. An electrical connector according to claim 21, wherein
said coupling member contact surface engages an outer surface of said coupling member and said connector body contact surface engages an outer surface of said connector body.

23. An electrical connector according to claim 21, wherein
said inner surface of said gripping sleeve includes a retaining member; and
said grounding member is located on or near said retaining member.

24. An electrical connector according to claim 23, wherein
said retaining member is a radially inwardly extending flange.

25. An electrical connector according to claim 21, wherein
said grounding member is a metal segment.

26. An electrical connector according to claim 25, wherein
said metal segment has a length sufficient to span a gap between said coupling member and said connector body.

27. An electrical connector according to claim 25, wherein
said metal segment has a cut-out section and an inwardly extending leg section; and
a second coupling member contact surface is disposed on said leg section for engaging said outer surface at the free end of said coupling member.

28. An electrical connector according to claim 21, wherein
said coupling member contact surface and said connector body contact surface are co-planar.

29. An electrical connector according to claim 21, wherein
said grounding member that includes a ring body.

30. An electrical connector according to claim 29, wherein
said ring body is substantially U-shaped in cross-section.

31. An electrical connector according to claim 29, wherein
said ring body includes a plurality of resilient fingers; and
said connector body contact surface is on said fingers.

32. An electrical connector according to claim 21, wherein
said grounding member is a metal segment with first and second resilient tabs, said first tab has said coupling member contact surface for engaging an outer surface of said coupling member and said second tab has said connector body contact surface for engaging an outer surface of said connector body.

33. An electrical connector according to claim 32, wherein
said metal segment includes a cut-out section adapted to receive a tab of said gripping sleeve.

34. An electrical connector according to claim 21, wherein
said gripping sleeve has first and second pieces that have corresponding alignment members.

35. An electrical connector according to claim 34, wherein
said first and second pieces are hinged together.

36. An electrical connector, comprising:
a connector body having opposite first and second ends, said first end being configured to be coupled with a prepared end of a cable;
a coupling member having an interface end configured to interface with a mating connector and a free end opposite said interface end that is rotatable with respect to said connector body at said second end of said connector body;
a gripping sleeve disposed on said coupling member such that said coupling member and said gripping sleeve are rotatable together with respect to said connector body, said gripping sleeve having an inner surface; and
means for grounding located on said inner surface of said gripping sleeve, said means for grounding providing a grounding path between said connector body and said coupling member.
